(19) United States
(12) Patent Application Publication
(10) Pub. No.: US 2015/0278971 A1
(43) Pub. Date: Oct. 1, 2015

(54) SYSTEM AND METHOD FOR FACILITATING REAL ESTATE SALES

(71) Applicant: Grant Moon, Union City, NJ (US)

(72) Inventor: Grant Moon, Union City, NJ (US)

(21) Appl. No.: 14/673,687

(22) Filed: Mar. 30, 2015

Related U.S. Application Data
(60) Provisional application No. 61/972,712, filed on Mar. 31, 2014.

(51) Int. Cl. G06Q 50/16; G06Q 30/06

(52) U.S. Cl. CPC G06Q 50/16; G06Q 30/06

(57) ABSTRACT

A system and method that allows the creation of a network of realtors and lenders, which allows the lenders to keep the maximum number of pre-qualified buyers, and the network allows the realtors to receive clients from the network. The system, method, and network of the present invention can also match an original lender in one state and the buyer that is looking for a home in a different state with the local realtor that will help the buyer find a suitable property in the state the buyer is looking in, without diverting the buyer to a different lender.

### CROSS REFERENCE OF RELATED APPLICATIONS

This patent application is a nonprovisional application of, and claims priority to, the provisional patent application Ser. No. 61/972,712 filed on Mar. 31, 2014, which is hereby incorporated by reference in its entirety.

### FIELD OF INVENTION

This invention relates to the field of real estate sales and facilitating real estate sales.

This invention was not made pursuant to any federally-sponsored research and/or development.

### BACKGROUND

This invention relates to a system and method for allowing the home loan lenders to keep as many of their customers as possible after the prequalification process. The system and method are computer-implemented through a combination of computer software and hardware.

Buying a new home has become a commonplace experience for people. The process typically involves a pre-approval or prequalification process of a home buyer, so that the buyer may offer to buy the property he or she want. The buyer's offer is supported by the mortgage pre-approval or pre-qualification letter from the lender, such as a bank or mortgage company.

The lenders usually review the buyer's assets and debts, income and regular payment obligations, credit history, percentage of the available credit utilized, and other factors to make the decision whether the buyer qualifies for a home loan, the amount of the loan the buyer qualifies for, if any, and whether the home will be a primary residence for the buyer. There are rules and guidelines the lenders follow to make these determinations, including what kind of a mortgage payment the buyer can afford per month with the available interest rate, as well as the percentage of the buyer's income that will go towards the mortgage payment. The amount of the loan and the interest rate are typically included in the pre-qualification letter. Oftentimes, the address and location of a particular property for which the buyer is seeking pre-qualification is listed as well, but it is possible for buyers to obtain a pre-qualification for a general home-loan amount, without having a particular property in mind.

The pre-qualification process has become indispensible because most potential buyers are required to provide a pre-qualification or pre-approval letter from a financial institution (i.e., home loan lender) in order for the buyer's offer to be considered. This is frequently done to weed out unreliable buyers and offers of the buyers who cannot reasonably afford a particular property.

However, the pre-qualification process is not binding on the lender, but, even more importantly, it is not binding on the buyer. The buyer is free to obtain a home loan from any lender other than the lender that pre-qualified the buyer. This frequently does happen because, when the buyer contacts a real estate broker or agent to buy a property. The real estate broker or agent frequently has a lending institution he or she works with or regularly recommends, and the broker or agent often steers the buyer to use this “preferred” lender. Thus, the buyer's own realtor is usually the person that severs the business link between the lender and the buyer.

This means that the originating lender, the institution that actually identified the buyer, i.e., the potential borrower and the source of profit, established a relationship with the buyer is not the actual lender that lends the money.

This loss of pre-qualified buyers causes the pre-qualification lender serious losses of business. The buyer who would be likely to come back to the lender that issued the pre-qualification letter (sometimes it's the buyer's own bank where the buyer keeps his or her accounts), instead applies for a home loan with the real estate broker's “preferred” or recommended lender. Additionally, the pre-qualification process is usually free for the buyer, so the costs are borne by the pre-qualifying lender. Without the buyer coming back to obtain a home loan, the time and effort spent by the lender on the pre-qualification are simply lost or wasted.

What is needed is a system and method that allows the lenders utilizing it make sure that they maximize the return ratio of the pre-qualified buyers. The present invention is directed towards this goal by giving the real estate brokers and agents an incentive not to steer the buyers towards other lenders, thus providing a remedy to the loss of pre-qualified buyers.

### SUMMARY

This invention meets the current need for a system and method that are used to maximize the return of the pre-qualified buyers. A computer-implemented system and method that give the real estate brokers and agents an incentive not to steer the buyers to other lenders are provided.

The system and method of the present invention comprise a network of lenders and realtors under agreement that allows the lender to maximize the number of customers they keep by leveraging the network. The agreement obligates the realtors not to steer the buyers towards the realtors' “preferred lenders” in exchange for the referrals of the buyers from the network. Thus, the lenders get to keep the buyers, and the realtors receive new clients that they would not otherwise have.

The lender creates the customer profile utilizing the user interface of the system and method of the present invention, and the lender uploads the customer profile, the Good Faith Estimate (“GFE”) and/or the pre-qualification information, preferably including the pre-qualification letter to the system and/or network Home Captain Lender Advantage Software System™. The lender then explains the advantages of the network, system and method of the present invention and obtains informed consent from the prospective buyer to use the system and method of the present invention. The lender then submits the uploaded information to the network and/or system).

The system and network receive this information and assign realtors to the buyer. The system identifies users based on their geographical area that they would like to purchase their home in and assigns an agent within the Home Captain Network.

The system, method, and network of the present invention can also match an original lender in one state and the buyer that is looking for a home in a different state with the local realtor that will help the buyer find a suitable property in the state the buyer is looking in, without diverting the buyer to a different lender.

This is the hallmark of the system and method of the present invention. Since lending has become and will continue to start in the Internet, the vast majority of the current lenders in the Home Captain Network are licensed to lend in all 50 states yet don't have brick and mortar presence in every state. Most brick and mortar establishments, however, have localized relationships with realtors. The system and method of the present invention serve as a conduit for the lender to have the realtor relationships in all 50 states through the system, network and software of the present invention.

### BRIEF DESCRIPTION OF THE DRAWINGS

These features, aspects and advantages of the novel system and method will become further understood with reference to the following description and accompanying drawings where

FIG. 1 is an overview of the process and flow of the system, method, network, and software of the present invention;

FIG. 2 is a summary of benefits of the system, method, network, and software of the present invention;

FIG. 3 is the summary of the network standards of the system, method, network, and software of the present invention;

FIG. 4 is an illustration of the lender administrator dashboard of the software of the present invention;

FIG. 5 is an illustration of the lender administrator control panel dashboard of the software of the present invention;

FIG. 6 is an illustration of the lender administrator customer profiles dashboard of the software of the present invention;

FIG. 7 is an illustration of the lender administrator customer profiles report dashboard of the software of the present invention;

FIG. 8 is an illustration of the loan officer dashboard of the software of the present invention;

FIG. 9 is an illustration of the loan officer customer profiles dashboard of the software of the present invention;

FIG. 10 is an illustration of the loan officer agent profiles dashboard of the software of the present invention;

FIG. 11 is an illustration of the loan officer customer profiles dashboard of the software of the present invention;

FIG. 12 is an illustration of the loan officer customer profiles dashboard of the software of the present invention;

FIG. 13 is an illustration of the Home Captain administrative panel dashboard of the software of the present invention;

FIG. 14 is an illustration of the Home Captain administrative panel customer profiles dashboard of the software of the present invention;

FIG. 15 is an illustration of the Home Captain administrative panel customer profiles report dashboard of the software of the present invention;

FIG. 16 is an illustration of the Home Captain administrative panel customer profiles dashboard of the software of the present invention;

FIG. 17 is an illustration of the Home Captain administrative panel documents dashboard of the software of the present invention;

FIG. 18 is an illustration of the Home Captain administrative panel lenders list dashboard of the software of the present invention;

FIG. 19 is an illustration of the Home Captain administrative panel agents list dashboard of the software of the present invention;

FIG. 20 is an illustration of the realtor customer list dashboard of the software of the present invention;

FIG. 21 is an illustration of the realtor lender and loan officer list dashboard of the software of the present invention;

FIG. 22 is an illustration of the realtor customer profiles list dashboard of the software of the present invention; and

FIG. 23 is an illustration of the realtor documents list dashboard of the software of the present invention.

### DESCRIPTION OF THE PREFERRED EMBODIMENT

The present invention is directed to a method and system that are utilized on a network of realtors and lenders, which allows the lenders to keep the maximum number of pre-qualified buyers (ideally, all of them), and the network allows the realtors to receive clients from the network. The realtor is contractually prohibited from interfering with the original lender-buyer relationship.

There are three critical components of the home buying process: the buyer, the lender, and the real estate broker or realtor. The buyer is the person who provides the money for the purchase of the home, and the buyer is the person with the most at stake. Part of the money for the purchase of the home comes from the lender.

The lender lends the money to the prospective buyer. The lender qualifies and approves the buyer for the home loan, and the lender receives interest on the loan, which the buyer pays in return for the loan (i.e., being able to buy the home the buyer wants).

The realtor facilitates the home buying process and operates at the local level because a particular realtor has a particular geographic area the realtor is familiar with and works in. The network unites and links the lenders and realtors, and the network allows the lenders to keep the buyers the lenders pre-qualified, as well as allows the realtors to receive new clients from the network.

The network comprises a computer, preferably a computer server, and software that runs identification and referral algorithms, using a database of lenders and a database of realtors. There are two separate databases: one that houses the lenders which are the clients of the Home Captain and the other that houses the network of realtors that Home Captain sends qualified candidates to. The system and network interface may operate through a website, preferably using a graphical user interface (GUI) for the lenders′, realtors' and administrators' interaction with the system.

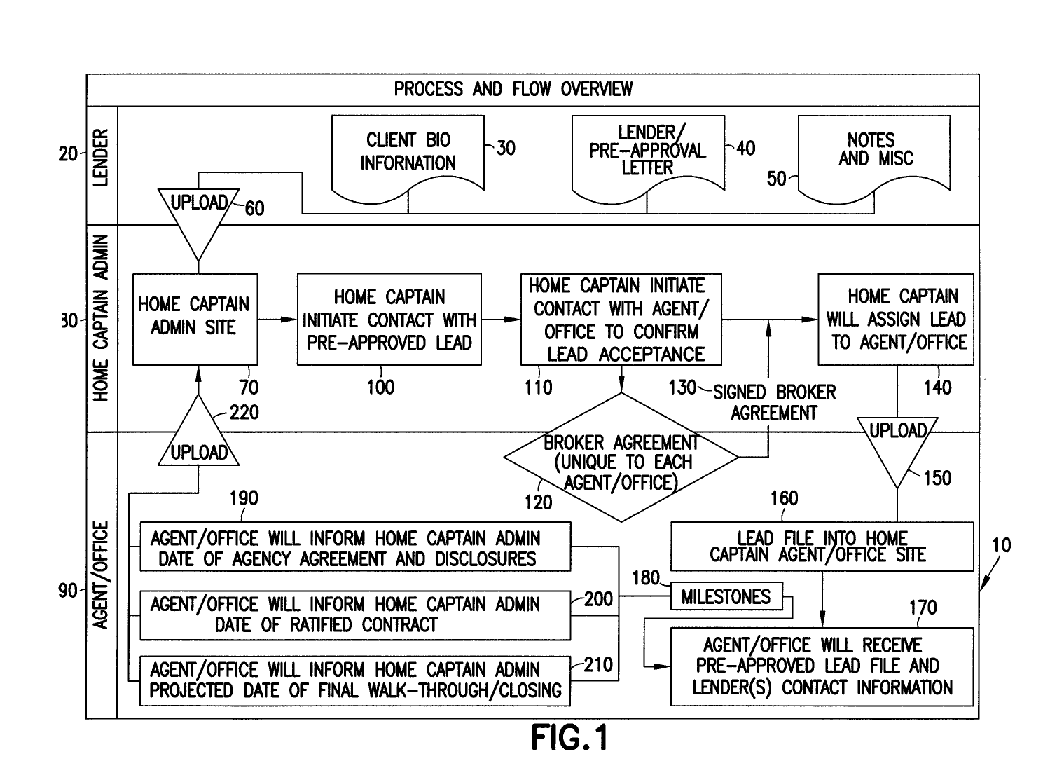

With reference to FIG. 1, the system 10 and method of the present invention are generally described as follows: a lender 20 generates a client (homebuyer) profile by entering the client information 30, the client pre-approval letter 40, and any miscellaneous notes 50 through the GUI installed on the lender's computer, which is connected to the system via a network, preferably via the Internet, but possibly via a local network. The lender then uploads 60 the customer information to the system 10 through the network. Once the information is uploaded to the system, which is preferably hosted on the administration website 70 of the system and network provider (Home Captain) 80, Home Captain initiates contact with a network realtor or real estate agent 90 with a pre-approved lead by contacting the realtor 90 with the uploaded customer profile 100. Home Captain then initiates contact with the assigned real estate agent/office 90 to confirm the acceptance of the assignment 110. A that point, Home Captain either signs a broker agreement with that particular agent/office 120, which is unique to that agent/office, or Home Captain already has a signed broker agreement with that particular agent/office on file 130. Then, Home Captain assigns the lead (homebuyer client) to that particular agent/office 140 and uploads 150 the client information and lead into the Home Captain agent/office site 160.

Further with reference to FIG. 1, the agent/office (realtor) 90 receives the pre-approved lead file of the client and the lender's contact information 170. The agent/office 90 then contacts the client (homebuyer) and reports the milestones 180 into the system 10, such as inform Home Captain of agency agreement and disclosures 190, inform Home Captain of ratified contract for the sale of a home 200, and inform Home Captain of the date of final walk-through and closing 210, which milestones 180 are uploaded 220 to the system 10, preferably individually when each milestone 180 is reached.

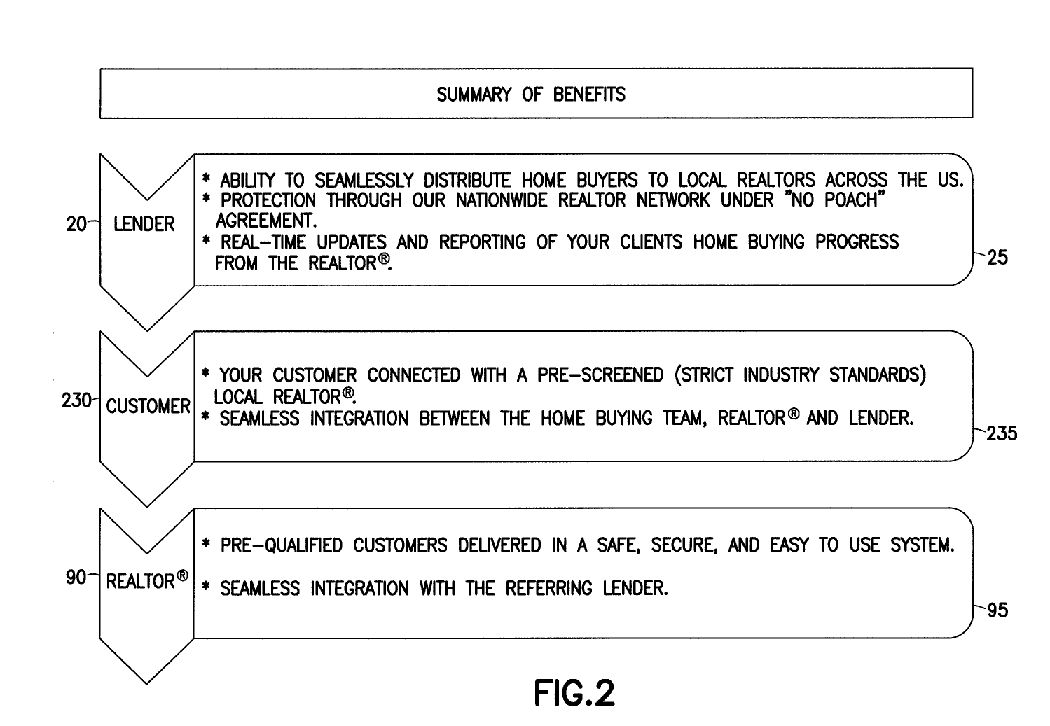

With reference to FIG. 2, the advantages of the present invention include the ability to seamlessly distribute homebuyer/customers 230 to local realtors 90 across the U.S., protection of the interests of the lender 20 in the preapproved homebuyer/customer 230, and real-time updates and reporting of the homebuying process 25, pre-screening local realtors 90 and connecting the homebuyer/customer 230 with the realtor 90, lender 20, and home buying team 235, and facilitating and integrating the connection of the homebuyer/customer 230 with a realtor 90 from the nationwide network of realtors 90 in a safe, secure, and easy to use system 95.

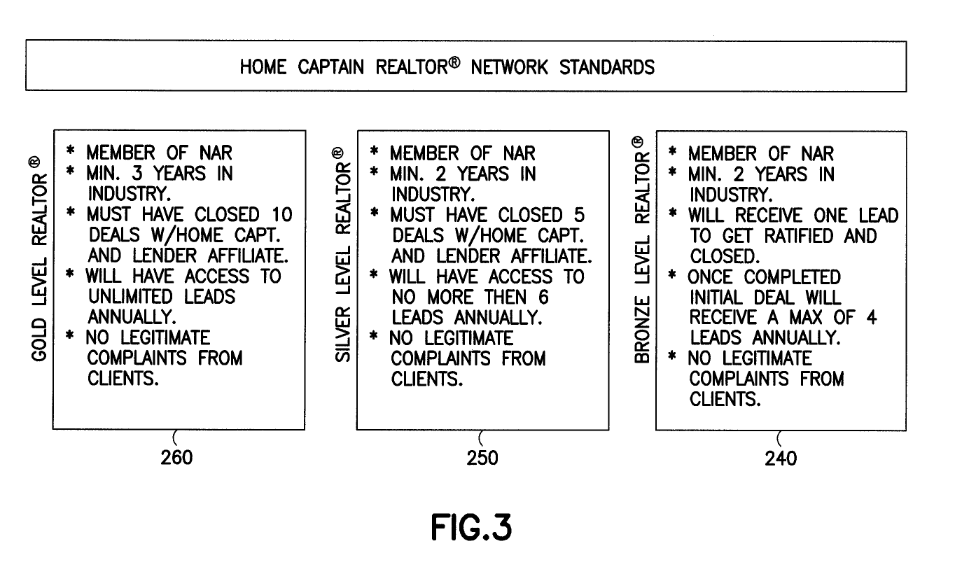

With reference to FIG. 3, the selection criteria of the realtors 90 is preferably divided into several subcategories. The Bronze Level Subcategory 240 requires a membership in the National Association of Realtors (NAR), a minimum of two years experience in the industry, and no legitimate complaints from homebuyer/customers 230. Compliance with these criteria entitles the realtor 90 to one lead to get ratified and closed, and upon successful completion, up to four leads annually. The Silver Level Subcategory 250 requires the realtor 90 to have closed five deals with Home Captain and the lender 20 affiliate, using the system and method of the present invention, in addition to the requirements of the Bronze Level Subcategory 240. The Silver Level Subcategory 250 entitles the realtor 90 to no more than six leads annually. The Gold Level Subcategory 260 requires three years of experience in the industry and closing at least ten deals in addition to the other requirements, which entitles the realtor 90 to unlimited leads annually.

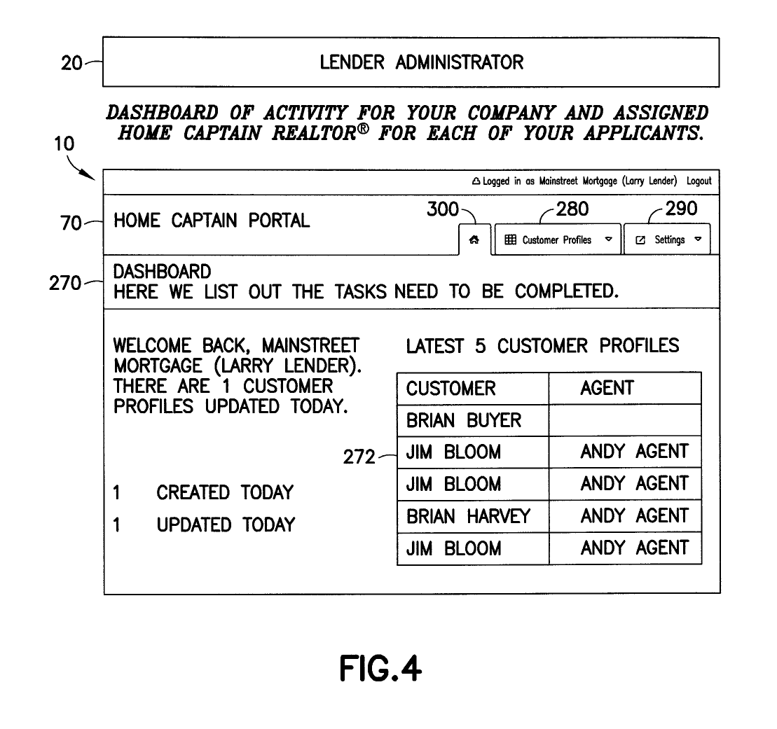

More specifically, with referenced to FIG. 4, the responsible person of lender 20, typically the assigned loan officer, logs into the system 10 and network of the present invention, which is preferably hosted on the administration website 70 of the system and network provider (Home Captain) 80, using a previously established username and password. The loan officer is then greeted by a functional dashboard 270 that shows the loan officer the tasks awaiting completion and the new actions that can be taken with respect to any new buyers. The dashboard 270 may also display the last several customer profiles 272 created by that lender or that particular loan officer, for example the last five buyer profiles. The loan officer may also access, view and change any and all customer profiles from the dashboard 270, create new customer profiles, and view reports from the “Customer Profiles” tab 280. The loan officer may also change the login settings and assign additional loan officers to participate in the system and network of the present invention by using the “Settings” tab 290, or hit the “Home” button 300 on the dashboard 270 to be returned to the initial screen, or log out of the system 10 and network.

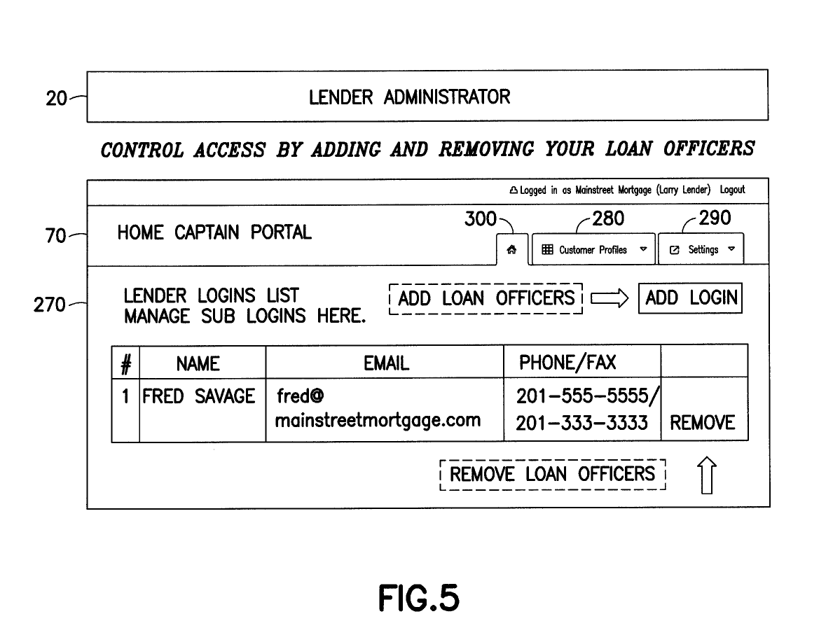

With referenced to FIG. 5, the lender 20 can have an administrator's log in, which is enabled to add or remove other users (loan officers) to the system 10 and network, hosted on the administration website 70 of the system 10 and network provider (Home Captain) 80, and assign long and passwords to the loan officers. The system 10 and network preferably show on the dashboard 270 who is currently logged in (i.e., Larry Lender of Mainstreet Mortgage, for example if that's the loan officer of the registered lender that is currently logged in).

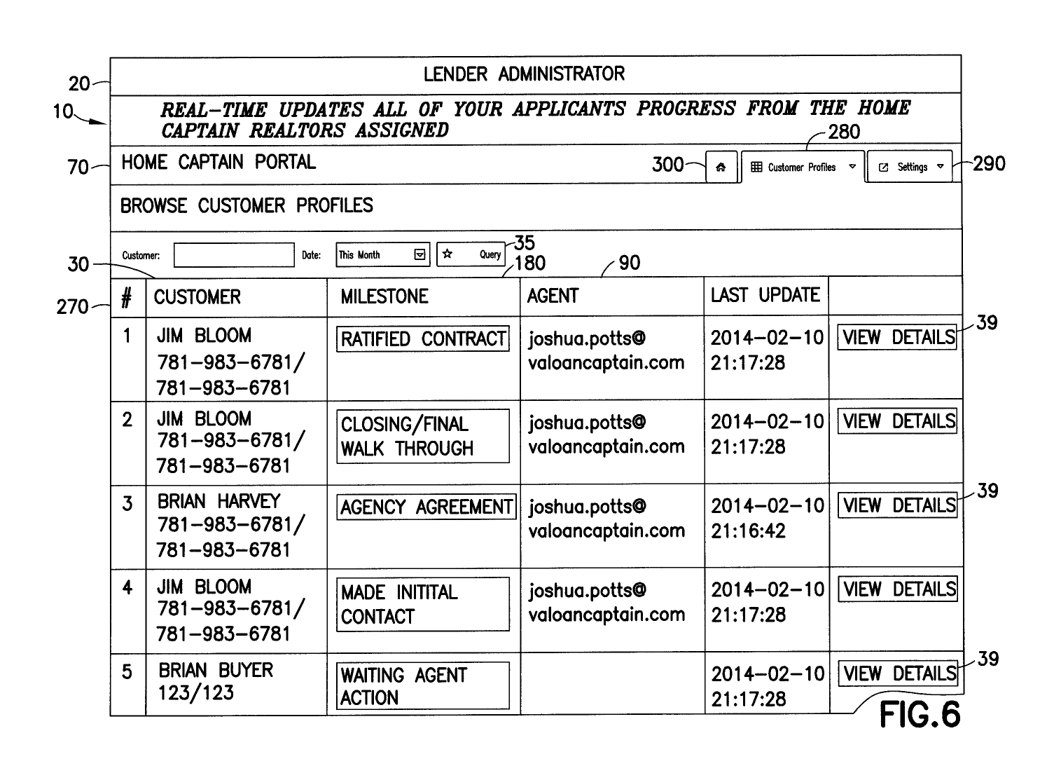

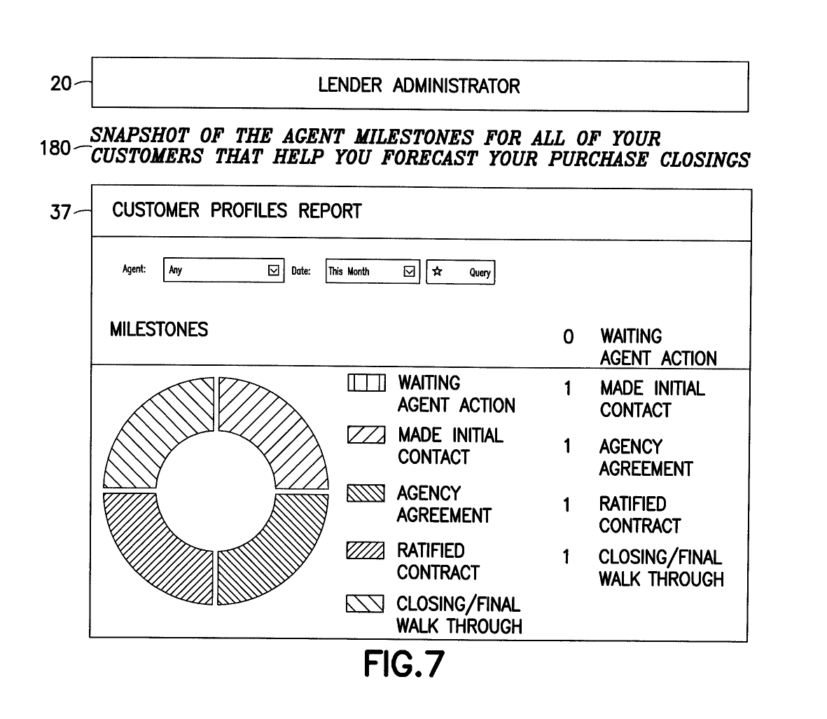

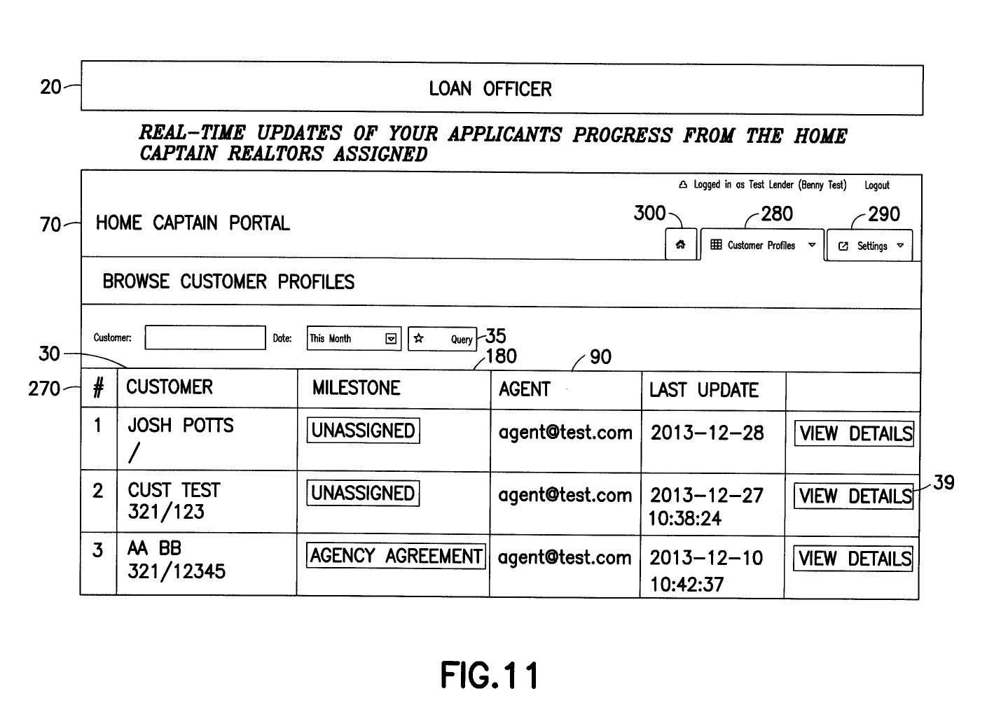

With reference to FIGS. 6 and 11, the dashboard 270 also displays an “Agent” 90 field associated with the customer 30 profiles, as well as the milestones 180 field. The agent 90 field is populated with the name and link to the contact information of the agent/realtor 90 assigned to the particular homebuyer (customer 30). When there is no agent/realtor 90 assigned yet, the field associated with the homebuyer is empty. The lender 20 may run a customer query 35 from the dashboard 270 and view the resulting snapshot of the agent milestones 180 in the resulting customer profiles report 37 illustrated in FIG. 7, or the other details accessible through this screen by clicking each respective “Vew Details” button 39 associated with each customer 30.

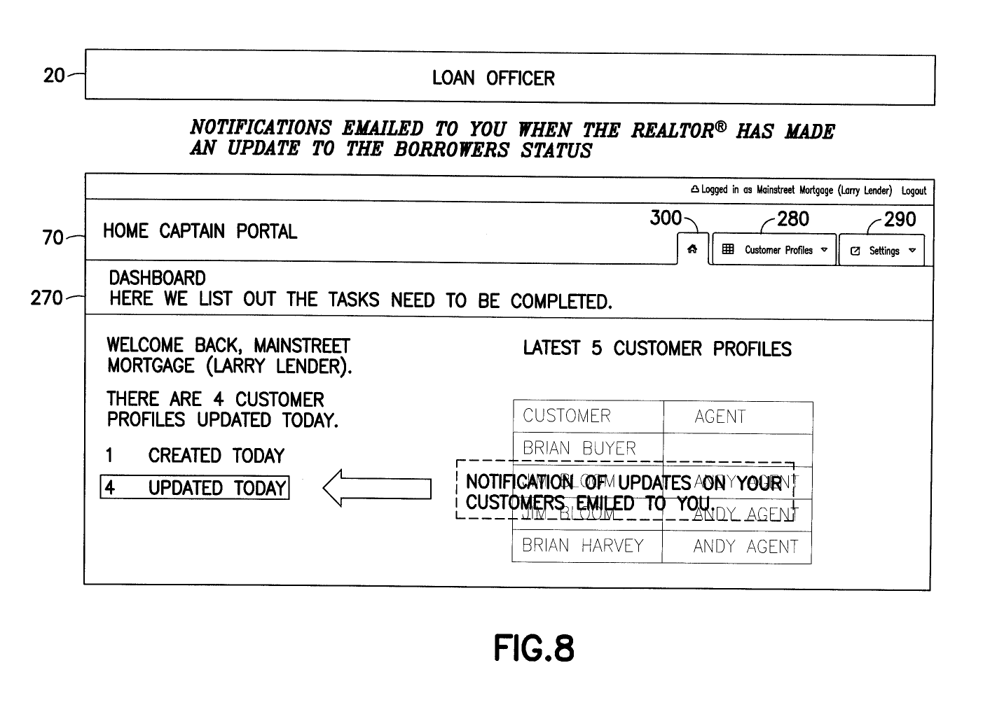

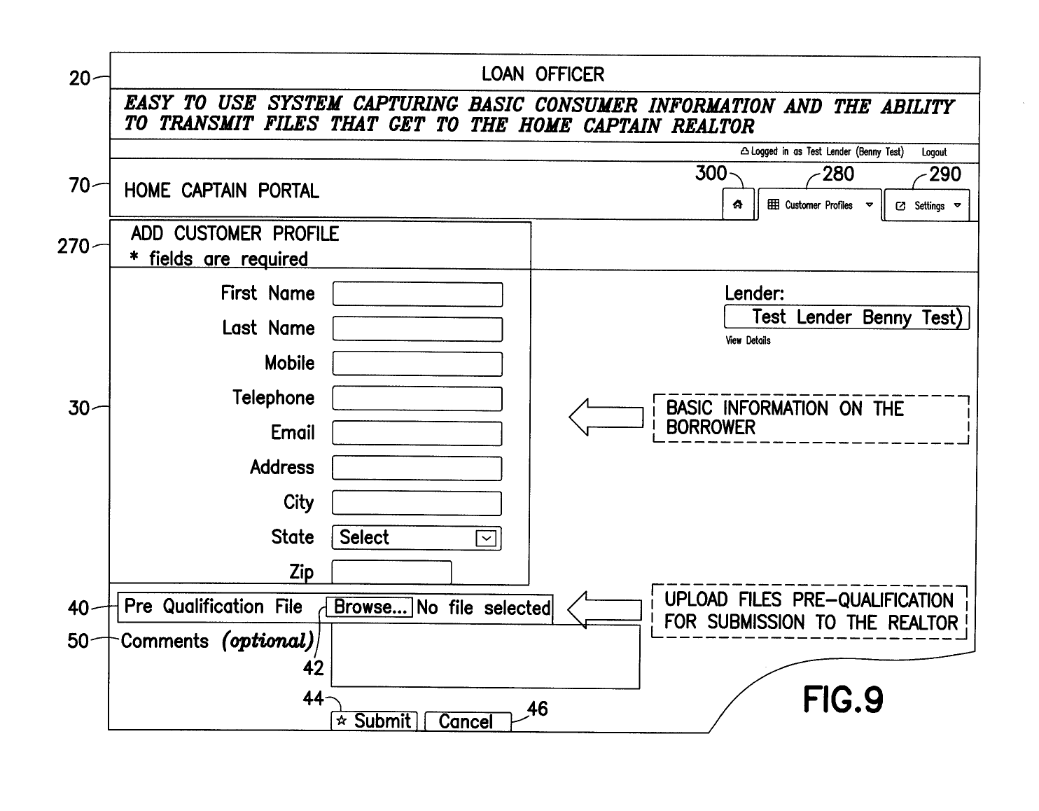

With reference to FIGS. 8-9, to create a new customer profile, the loan officer of the lender 20 clicks the “Customer Profiles” tab 280 in the dashboard 270 of the administration website 70 of the system and network provider (Home Captain) 80, and from the dropdown menu of the “Customer Profiles” tab 280 selects “New Customer Profile” to create a new homebuyer profile for a customer 30. The loan officer is then presented with the screen where the loan officer initially enters all of the pertinent buyer's information: first and last name, address, telephone and mobile telephone numbers, email address, city, state, zip code, pre-qualification file (i.e., the GFE, pre-approval or pre-qualification letter 40, optional comments of the loan officer 50, and whatever other information is desired. The pre-qualification file is attached by clicking a browse button 42 that opens the File Upload window, whereby the loan officer of the lender 20 may browse and select the file to be uploaded. The loan officer then clicks the “Submit” button 44 to upload the customer information to the system 10 and network of the present invention. There is also a “Cancel” button 46 next to the “Submit” button should the loan officer of the lender 20 wish to cancel the transaction or begin a new one.

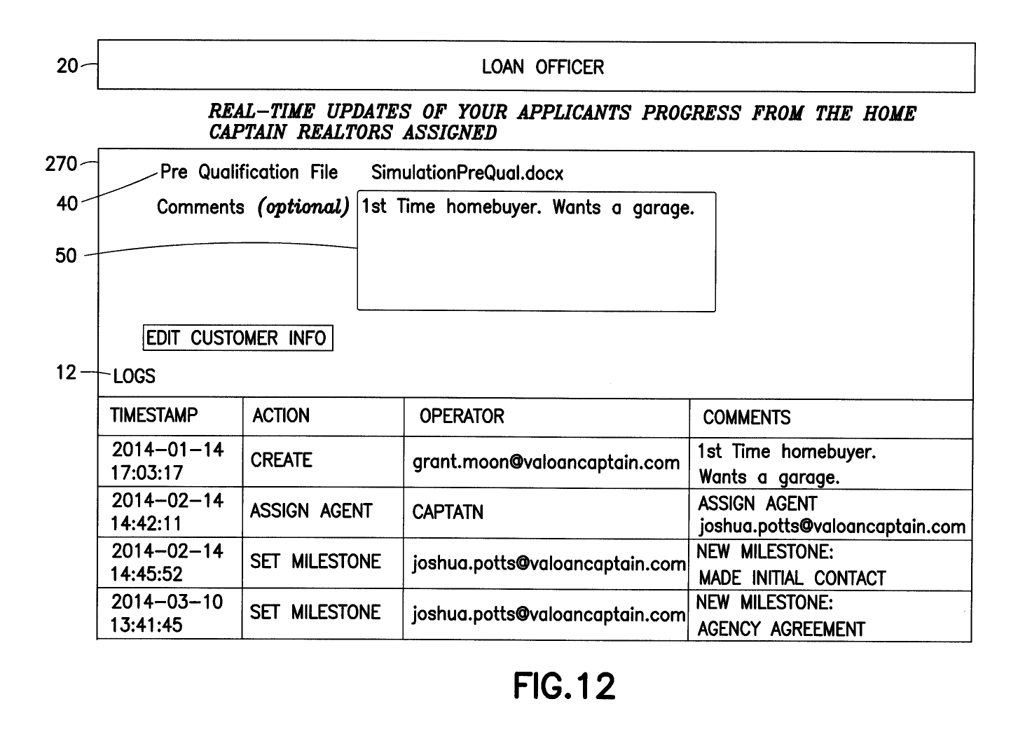

The upload of the pre-qualification letter 40 is illustrated in FIG. 12, where the lender 20 uses the dashboard 270 to upload the pre-qualification letter 40 and may also enter the optional comments of the loan officer 50. The system 10 keeps logs 12 of the information entered, including the action, its timestamp, operator and comments.

Once the loan officer 20 submits the customer 30 information, the loan officer is taken to the “Browse Customer Profiles” screen illustrated in FIGS. 6 and 11, where the loan officer may review and observe the list of customers 30 and their contact information, the current milestone 180 in the system 10 and network (i.e., “Waiting Agent Action” or other), the date of the last file update, and the other details accessible through this screen by clicking each respective “Vew Details” button 39 associated with each customer. The loan officer can also run a query 35 from this screen, by entering the customer name into a search window or selecting a time period/date to view (i.e., this month, this week, etc.).

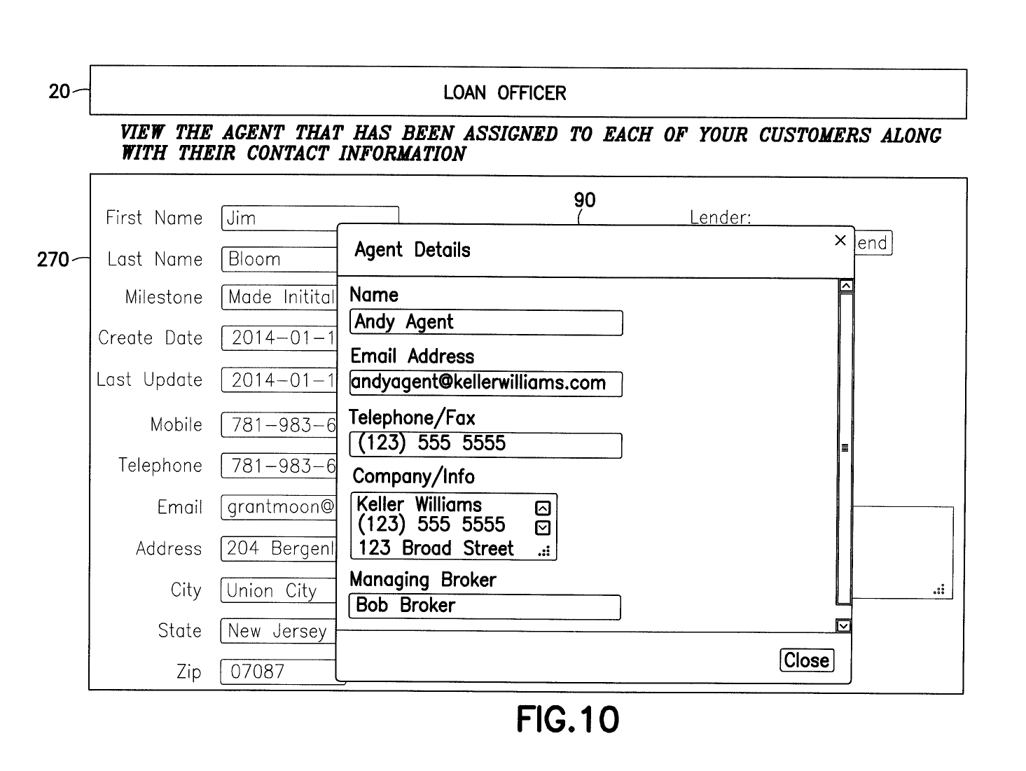

As illustrated in FIGS. 10-11, the loan officer of the lender 20 also has access, through the dashboard 270, to the agent/realtor 90 information about the agent/realtor 90 that has been assigned to each customer 30, including the agent/realtor 90 contact information.

This process represents tremendous utility to the lender 20, which is able to upload the customer's information to the system 10 and network of the present invention, and have an agent/realtor 90 assigned to any of the lender's customers 30 that want to be assigned a realtor, which realtor 90 will not interfere between the lender 20 and the customer 30.

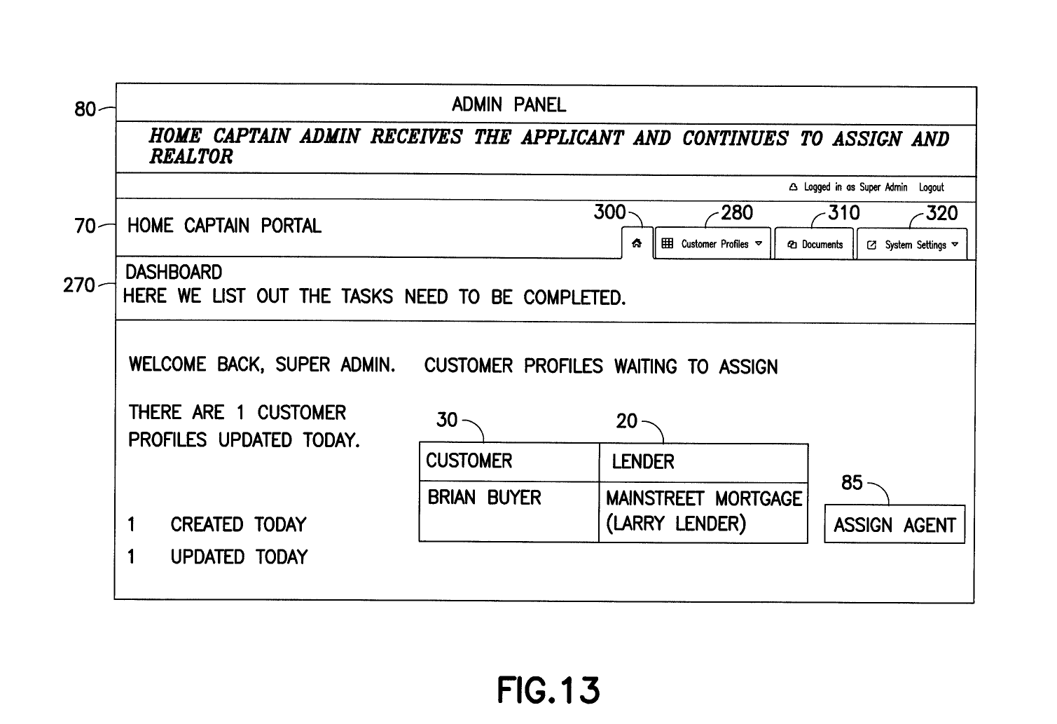

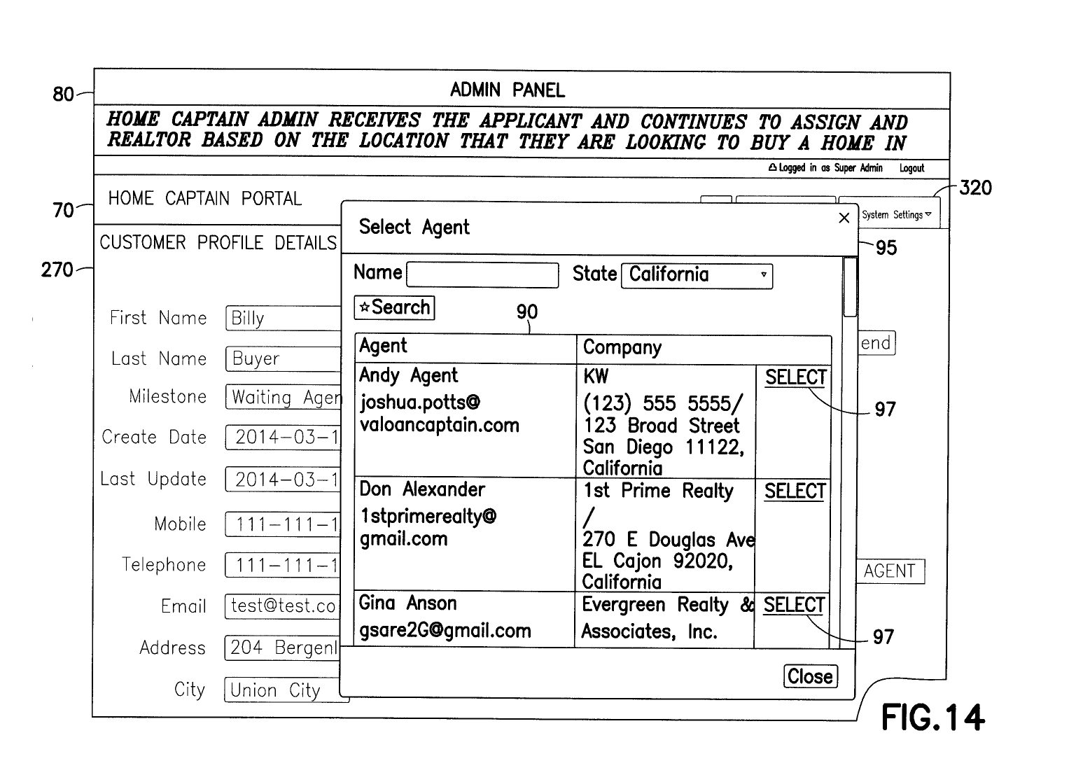

With reference to FIGS. 13-14, after the customer 30 profile and the associated information and pre-qualification letter 40 are received by the system 10 on the administration website 70 of the system 10 and network provider 80 (Home Captain), an operator of the system 10 and software manually assigns the customer 30 to a network realtor 90 through the dashboard 270. Home Captain 80 typically looks for a network realtor 90 within 50 miles of where the prospective buyer (customer 30) is looking to buy real property. The Home Captain 80 administrator also has options available to access the Documents 310 or set the System Settings 320.

An alternative embodiment of the present invention may automatically assign an in-network real estate agent 90, including assigning by the zip code where the buyer is looking to buy. The network provider 80 receives a notification that the new buyer 30 file has been created and is awaiting action, as well as what information and/or pre-qualification letter 40 has been uploaded for this particular buyer. The network provider 80 can monitor the information and take actions from the administrative panel that is built into the network and the system 10 of the present invention.

Further with reference to FIGS. 13-14, the responsible person (administrator) of the network provider 80 logs into the system 10 and network of the present invention using a previously established username and password. The administrator 80 is greeted by a functional dashboard 270 that shows the administrator 80 the Customer Profiles waiting to assign, customer 30 information, their original lender 20, and other tasks awaiting completion. The administrator 80 can take a number of actions with respect to the customer profiles, such as view the customer information, or the information of the originating lender associated with that customer, or assign a realtor to any customer by clicking the “Assign Agent” button 85 associated with each Customer Profile.

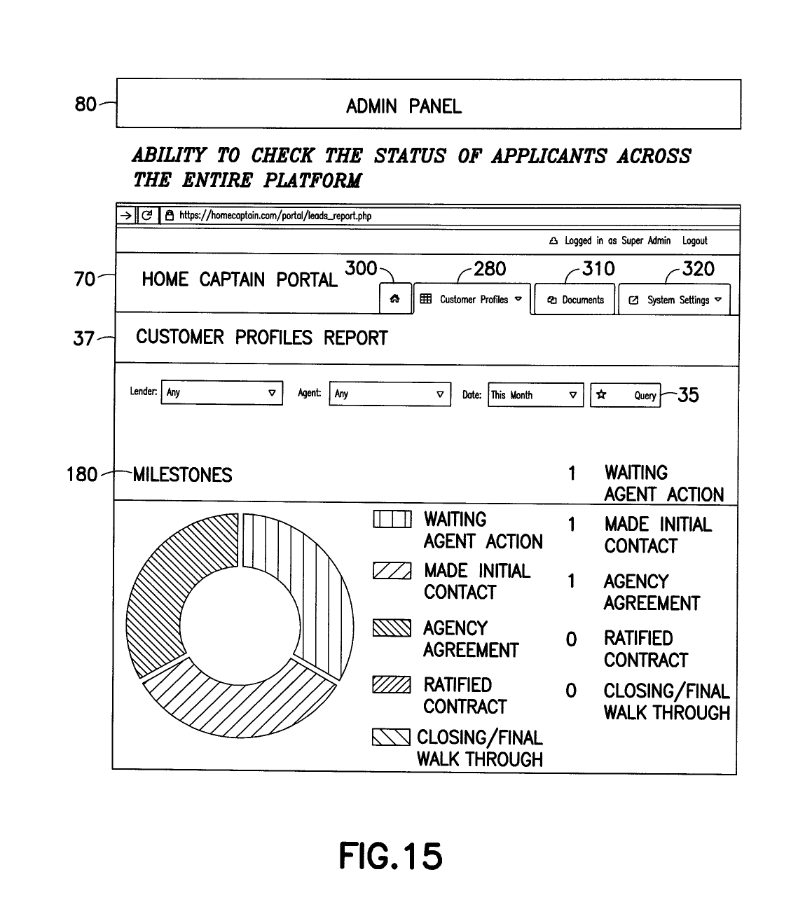

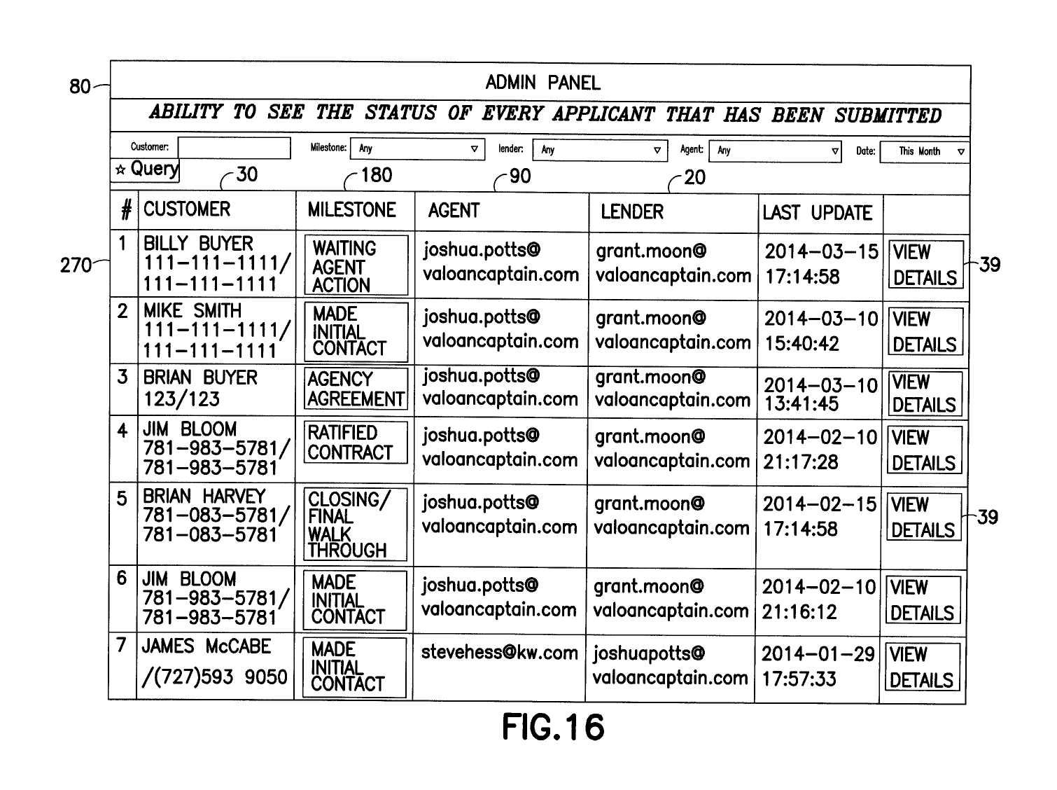

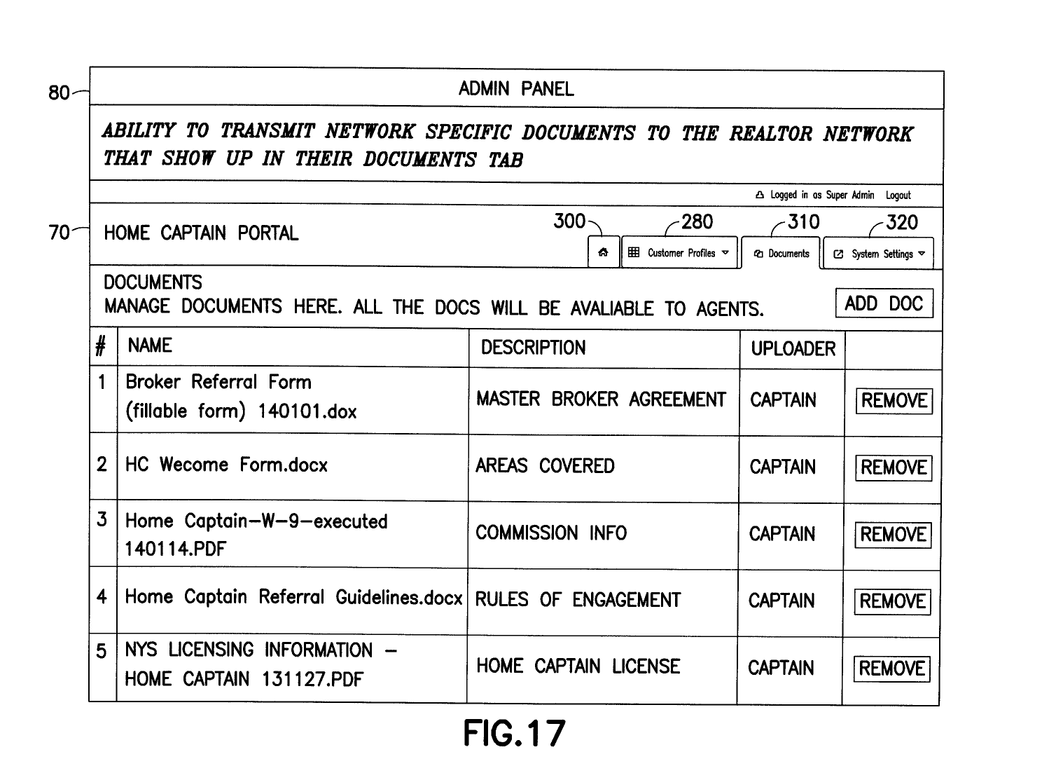

Further with reference to FIGS. 13-14, the administrator 80 may also access and view any and all available documents from the dashboard 270 by clicking the “Documents” tab 310, which is illustrated in FIG. 17, as well as access and view and customer profiles and view reports by clicking the “Customer Profiles” tab 280, which is illustrated in FIG. 15. The administrator 80 may use the query button 35 in FIG. 15, to search customer profiles, and view the resulting customer 30 report illustrated in FIG. 16, including information on each customer 30, associated agent 90 and lender 20, the current milestone 180, the last update date and time and the details that can be viewed by clicking on the view details button 39.

Further with reference to FIGS. 13 and 15, the administrator 80 may also change the login settings and assign additional administrators to manage the system and network of the present invention by using the “System Settings” tab 320, or hit the “Home” button 300 on the dashboard 270 to be returned to the initial screen, or log out of the system 10 and network.

With reference to FIG. 14, the selection and assignment of the agent/realtor 90 is as follows: the administrator 80 searches a database 95 of local realtors 90, which database 95 is part of the system 10, and selects a suitable local realtor 90, who is under an agreement with the network provider 80. The administrator 80 searches for a realtor 90 by name, state, or by using other search criteria. When the search results are displayed to the administrator 80, including the realtor's name, email, company, address and other identifying and/or contact information, the administrator selects a desired realtor by clicking the “SELECT” link 97 next to that realtor 90. The name of the realtor 90 then populates the “Assign Agent” field in the customer 30 and lender 20 information created and uploaded by the lender 20 to the system 10 and network of the present invention. The Administrator 80 then clicks the “Assign” button to complete the process of assigning the realtor 90 to a particular buyer 30, which assigns the realtor 90 to this particular buyer 30 and the buyer's file within the system 10 and the network.

The agreement with the realtors 90 in the database 95 has “no-poach” provisions that stipulates that the respective realtor 90 cannot interfere in the relationship between the lender 20 who collected, uploaded and provided the buyer 30 information and the buyer 30. The “no-poach” agreement contractually ensures that the realtor 90 will not steer the buyer 30 towards another lender, other than the pre-qualifying lender 20.

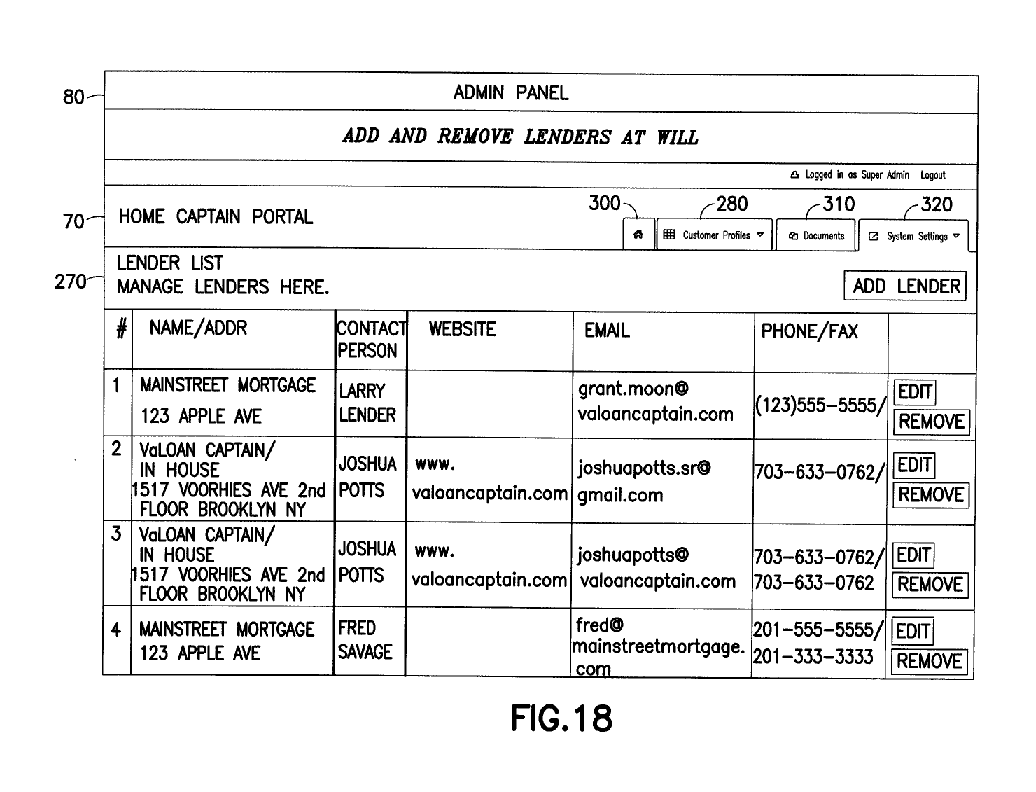

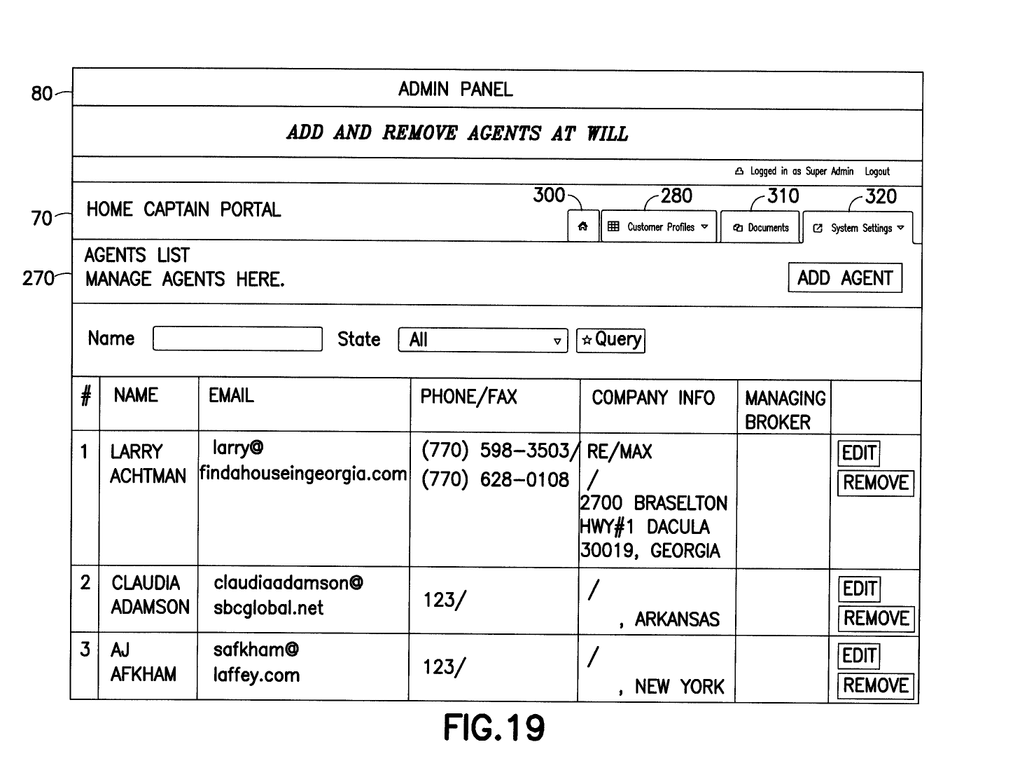

With reference to FIGS. 18-19, the administrator 80 also has the options of removing and adding lenders 20 and agents/realtors 90 at will through the dashboard 270 of the Home Captain 80 administrative website 70 hosting the system 10 and network of the present invention. The lender 20 information preferably includes the name and address, contact person name, website, email address, telephone and facsimile numbers, and other options as desired, as illustrated in FIG. 18. The agent/realtor 90 information preferably includes the name and address, contact person name, website, email address, company name and information, telephone and facsimile numbers, managing broker name, and other options as desired, as illustrated in FIG. 19.

The system 10 and software of the present invention then automatically sends a notification to the selected realtor 90 that the realtor 90 has been assigned to this particular customer 30 (home buyer), which notification is preferably sent via email, but it could also utilize telephone, voicemail, text messaging, multimedia messaging, or regular mail. Alternatively, an administrator 80 may make the selection and send the notification manually. The realtor 90 then logs into the system using a username and password the realtor 90 previously established, after entering into an agreement with the network provider 80 and providing all of the realtor's necessary contact and professional information. The system 10 of the present invention logs all of the actions and assignments and keeps track of the relationship between the lender 20, realtor 90, and buyer 30. The system 10, for example, logs the date and time of each action, and the operator performing the action, such as the realtor assignment.

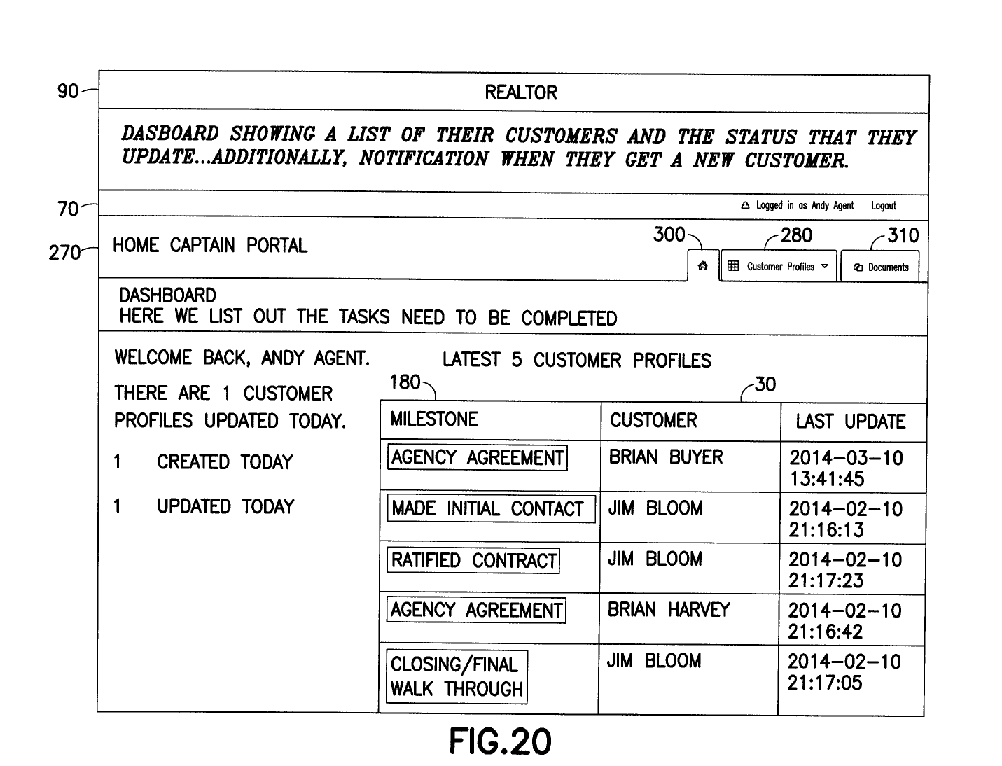

With reference to FIG. 20, after receiving the notification of his or her assignment, the realtor 90 logs into the system 10 and network of the present invention and obtains all of the customer profile information from the system 10 uploaded by the lender 20 and the information on when it was created. The realtor 90 sees who the Lender and the Lender's loan officer 20 is in the customer profile information, and the realtor 90 is contractually obligated not to interfere with the relationship between the buyer 30 and the lender 20. The realtor 90 also sees the list of customer profiles in the dashboard 270, including the customer 30, the milestone 180 achieved, and the last update date and time. From the Home tab 300, the realtor 90 may access the Customer Profiles tab 280 and the Documents tab 310 to view additional information.

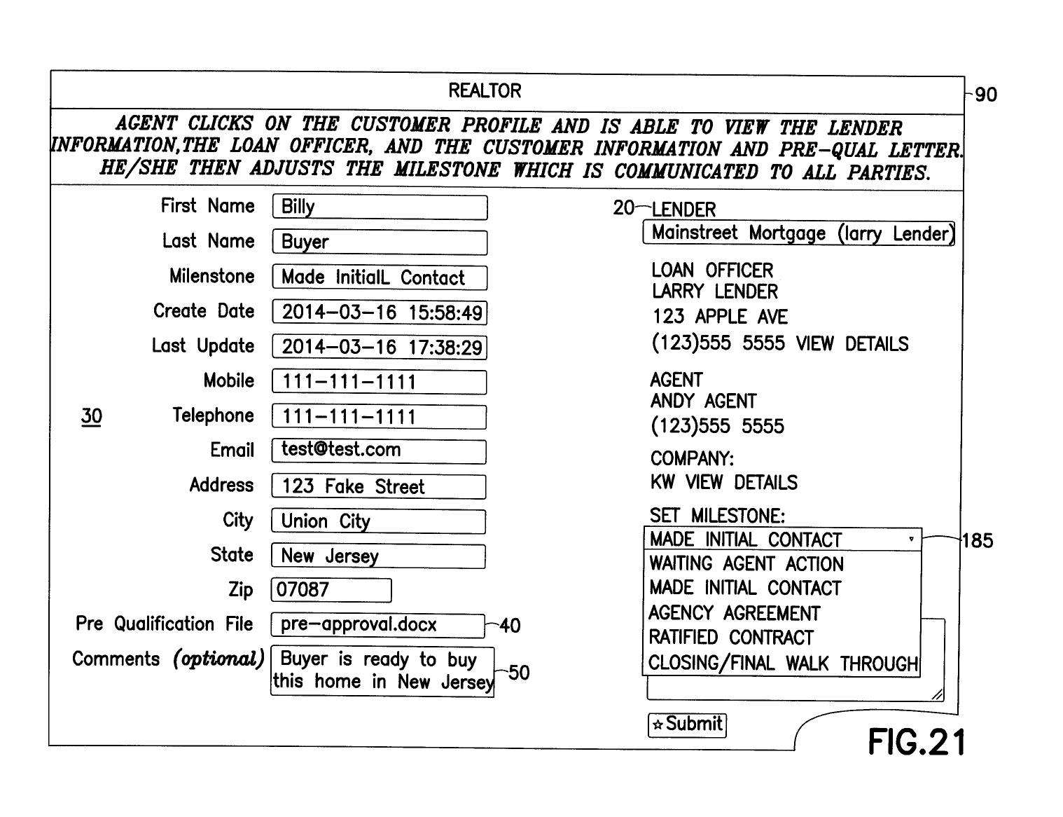

The Customer Profile 280 view is illustrated in FIG. 21: the realtor 90 sees the name, milestone, create and last update dates, telephone numbers, address, and other contact information of the customer 30, and the pre-qualification file 40 and optional comments 50. The realtor 90 also sees the information about the lender 20, including the loan officer's name, address, telephone numbers, company name, and is able to set the milestone 180 using a drop-down menu 185.

The realtor 90 then contacts the buyer 30 via telephone, email, or any indicated preferred method of contact by the buyer 30. The realtor 30 enters into a separate commission agreement (agency agreement) with the buyer 30 and then works with the buyer 30 to find a suitable property for the buyer 30 or advises the buyer 30 on the market value of the property the buyer 30 already found. The lenders 20 preferably only send clients (buyers) 30 that specifically need a realtor's services to purchase the property. Therefore, the realtor 90 would have an easy deal as the buyer 30 already has a property, and the realtor 90 would still represent the buyer 30.

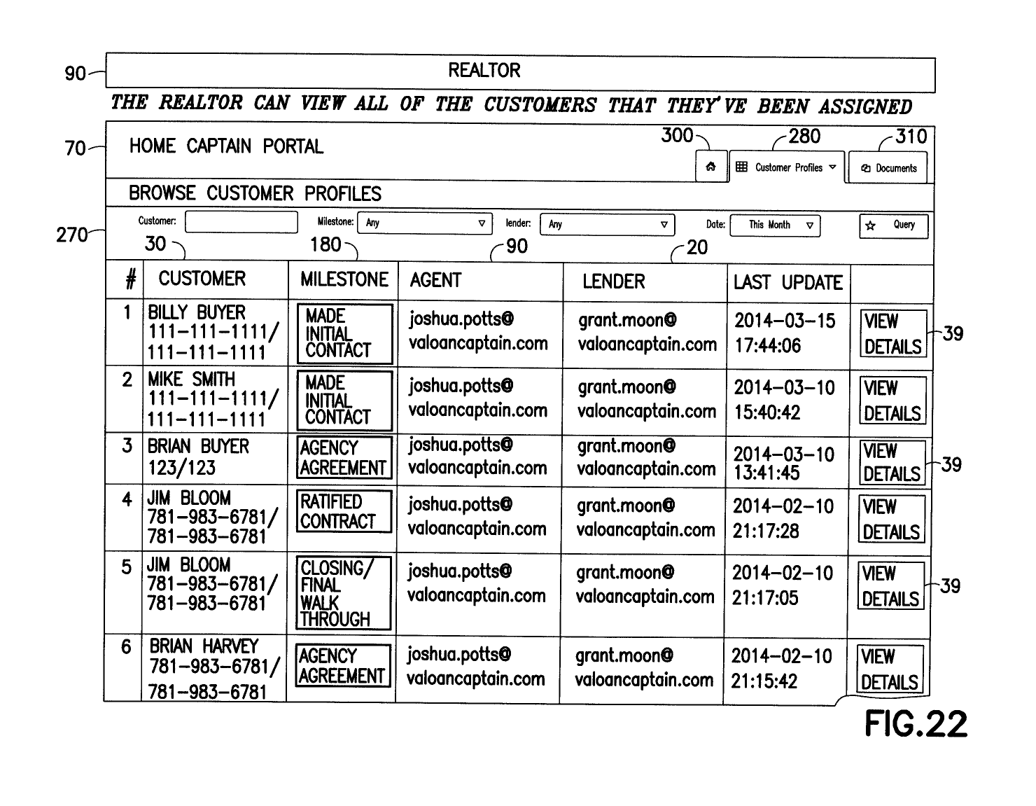

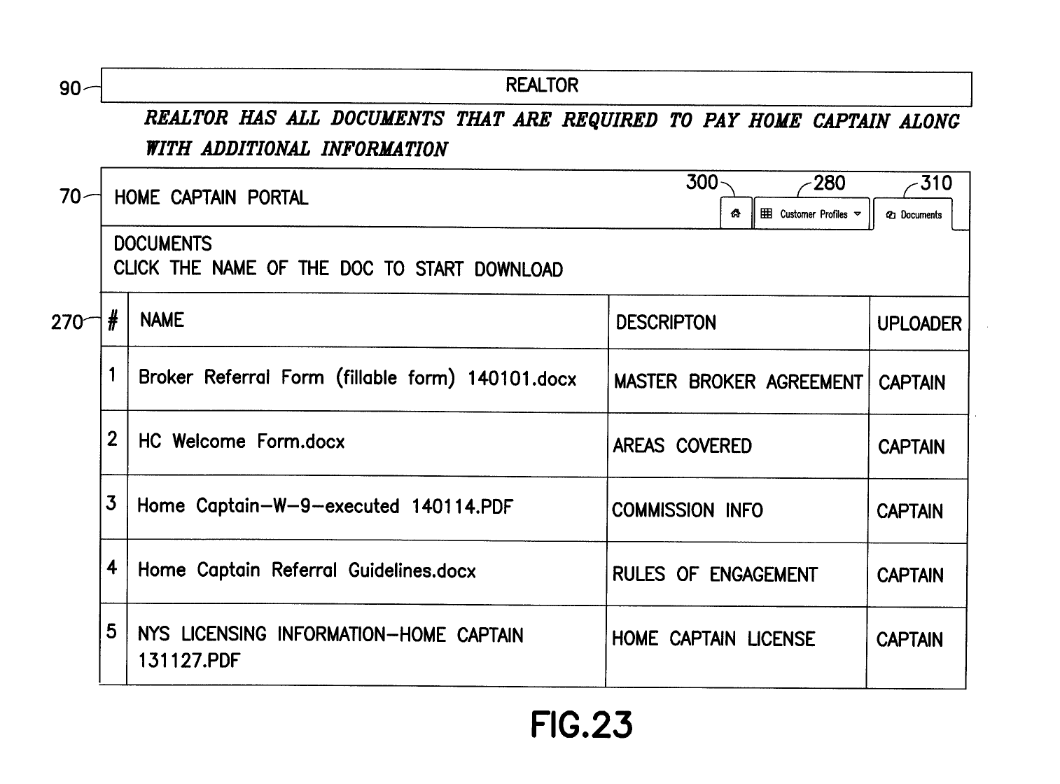

As Illustrated in FIG. 22, in the Customer Profiles 280 tab of the dashboard 270 hosted on the administration website 70 of the system 10 and network provider (Home Captain) 80, the realtor 90 may also set the milestones 180 associated with the customer 30 profile to the current status of the process, including “Waiting Agent Action”, “Made Initial Contact”, “Agency Agreement”, “Ratified Contract”, and “Closing/Walk Through.” The realtor may also view details of a particular customer 30 using the buttons View Details 39 or add comments associated with the milestone, such as “I spoke with the borrower and we are looking for a home” and submit the milestone and comments, which updates the customer information in the system and network of the present invention. The realtor 90 may further use the Home tab 300 or the Documents tab 310 for access to more information, such as the uploaded documents in Documents tab 310 illustrated in FIG. 23, which documents are categorized by name, description, uploader, and any other desired parameters, and which documents may be downloaded by the realtor 90.

The milestone update submitted by the realtor 90 is then communicated back to the lender and its loan officer 20 via the network and system 10 of the present invention. The lender 20 can near instantly see the milestone update from the realtor 90. The dashboard 270 accessible to the lender 20 displays the name of the assigned realtor 90 in the “Agent” field associated with the customer 30 profile as soon as the agent is assigned by the administrator 80 of the network and system 10. The field is populated with the name and link to the contact information of the realtor 90 assigned to the particular buyer 30. The lender or loan officer 20 can see who the realtor 90 is, what the current milestone 180 of the process is, and the lender or loan officer 20 may follow up with the realtor 90 regarding the customer 30 file if desired. The lender or loan officer 20 can also see the realtors' office information and who the managing broker of the respective agent is.

At that point, all the three crucial elements of the home buying process are connected through the system 10 and network of the present invention, and the system 10 displays the log of actions (date/time/operator/comments) so that the lender 20, realtor 90, and administrator 80 know at any given time what the stage of the home buying process is. The lender 20 is connected to the realtor 90, with whom the lender 20 may have no prior relationship, and the realtor 90 may be many states away for all practical purposes.

When the realtor 20 logs into the system 10 and network of the present invention using a previously established username and password, the realtor 90 is greeted by a functional dashboard 270 that shows the realtor 90 the Customer Profiles, including their original Lender 20, and other tasks awaiting completion, such as “Waiting Agent Action”. The realtor 90 can take a number of actions with respect to the customer profiles, such as view the customer information, or the information of the originating lender associated with that customer by clocking the customer name/link or by using the “Customer Profiles” 280 tab, and the realtor 90 may view documents associated with the customer profile by clicking on the “Documents” tab 310.

One of the advantages of the system, method, and network of the present invention is the ability to match the original lender, whatever state it may be in, with the buyer that is looking for a home in a completely different state, and match the buyer with the local realtor that will help the buyer find a suitable property.

After the real estate broker find a real property acceptable to the buyer, the buyer makes an offer on the property, and the offer is accepted by the seller, the buyer enters into a contract for the purchase of the property. After the completion of these initial stages, the buyer then returns to the same lender that issued the buyer's pre-qualification to apply for the home loan for the actual property.

The advantages of the system and method of the present invention are such that the lender is directly connected to the buyer and the realtor through the system and network, and the realtor is also directly connected to the buyer, but the realtor does not interfere with the lender-buyer relationship. This three-way connection and communication through the system and network of the present invention allows the lender and the realtor to receive real-time or near-real-time updates concerning the buyer, the buyer's information, the property, and the stage the home buying process is in (i.e., searching for a property, offer, contract stage, home loan approval stage, etc.).

The lender information database preferably includes the lender's name (financial institution), the name of its subsidiary or branch directly responsible for the buyer and the loan, the physical address of the lender, telephone number and facsimile number of the lender, a website and/or email of the lender and other identifying and contact information. The lender and the realtor databases are separated in the system, network and software of the present invention. The lender information also preferably includes the information of the loan officer responsible for the buyer/buyer's home loan, including the loan officer's full name, username and password for accessing the system and network of the present invention, and other contact information.

The realtor information database likewise includes the includes the realtor's name (institution or person), the name of its branches if an institutional realtor, the physical address of the realtor, telephone number and facsimile number of the realtor and/or branch, a website and/or email of the realtor and other identifying and contact information. The realtor information also preferably includes the information of the particular realtor, including full name, company and organizational affiliations if any, username and password for accessing the system and network of the present invention, and other identifying and contact information.

The above description of the disclosed preferred embodiments is provided to enable any person skilled in the art to make or use the invention. Various modifications to these embodiments will be readily apparent to those skilled in the art, and the principles described herein can be applied to other embodiments without departing from the spirit or scope of the invention and the subject matter of the present invention, which is broadly contemplated by the Applicant. The scope of the present invention fully encompasses other embodiments that may be or become obvious to those skilled in the art.

1. A method for facilitating real estate sales, comprising the steps of:
a. Entering into an agreement with at least one participating realtor, said agreement obligating the at least one participating realtor not to steer homebuyers away from referring lenders in exchange for referrals of the homebuyers to the at least one participating realtor;
b. Receiving a profile of a homebuyer and at least one preapproval document from a referring lender;
c. Assigning one of the at least one participating realtor to the homebuyer profile;
d. Referring the homebuyer to the one of the at least one participating realtor; and
e. Facilitating a purchase of a home for the homebuyer by the one of the at least one participating realtor, wherein the referring lender provides financing to the homebuyer for the purchase of the home.

2. The method for facilitating real estate sales of claim 1, the method further comprising: accepting the homebuyer referral by the one of the at least one participating realtor.

3. The method for facilitating real estate sales of claim 2, the method further comprising: confirming acceptance of the homebuyer referral by the one of the at least one participating realtor.

4. The method for facilitating real estate sales of claim 1, the method further comprising: providing the referring lender contact information to the one of the at least one participating realtor.

5. The method for facilitating real estate sales of claim 1, wherein the one of the at least one participating realtor is assigned based on the analysis of a geographical area the homebuyer would like to purchase the home in.

6. The method for facilitating real estate sales of claim 5, wherein the analysis of the geographical area indicates the one of the at least one participating realtor familiar with the geographic area.

7. The method for facilitating real estate sales of claim 1, the method further comprising: preapproving or prequalifying the homebuyer by the referring lender to generate the at least one preapproval document prior to receiving the profile of the homebuyer.

8. The method for facilitating real estate sales of claim 1, the method further comprising: obtaining informed consent from the homebuyer by the referring lender to use the method for facilitating real estate sales prior to receiving the profile of the homebuyer and the at least one preapproval document from the referring lender.

9. The method for facilitating real estate sales of claim 1, the method further comprising: individually reporting milestones during a process of the purchase of the home by the one of the at least one participating realtor.

10. The method for facilitating real estate sales of claim 9, wherein the milestones are selected from the group consisting from acceptance of the referral, confirmation of acceptance of the referral, making initial contact with the homebuyer, realtor disclosures, realtor contract, signed contract for purchase of the home, walk-through of the home, and closing.

11. The method for facilitating real estate sales of claim 1, the method further comprising: creating the profile of the homebuyer by the referring lender prior to receiving the profile of the homebuyer.

12. The method for facilitating real estate sales of claim 11, wherein the profile of the homebuyer includes at least homebuyer's information.

13. The method for facilitating real estate sales of claim 1, the method further comprising: prior to entering into the agreement with the least one participating realtor, preapproving the at least one participating realtor pursuant to a plurality of pre-selected criteria.

14. The method for facilitating real estate sales of claim 13, wherein the plurality of pre-selected criteria are selected from the group consisting from level of realtor participation, membership in the National Association of Realtors, number of years of experience, lack of legitimate complaints from homebuyers, and number of deals ratified and closed.

15. A method for facilitating real estate sales, comprising the steps of:
a. Receiving a profile of a homebuyer and at least one preapproval document from a referring lender;
b. Assigning one of at least one participating realtor to the homebuyer profile;
c. Referring the homebuyer to the one of the at least one participating realtor; and
d. Facilitating a purchase of a home for the homebuyer by the one of the at least one participating realtor, wherein the referring lender provides financing to the homebuyer for the purchase of the home.

16. The method for facilitating real estate sales of claim 15, the method further comprising: entering into an agreement with the at least one participating realtor, either before or after referring the homebuyer to the one of the at least one participating realtor, said agreement obligating the at least one participating realtor not to steer homebuyers away from referring lenders in exchange for referrals of the homebuyers to the at least one participating realtor.

17. A computer-implemented system and network for facilitating real estate sales, comprising:
a. a computer server accessible through a network by at least one remote user, said computer server having a graphical user interface installed on the computer server or a separate computer connected to the computer server for an administrator's access;
b. a database containing at least one referring lender hosted on the computer server;
c. a database containing at least one participating realtor hosted on the computer server, wherein each of the at least one participating realtor enters into an agreement obligating said each of the at least one participating realtor not to steer homebuyers away from referring lenders in exchange for referrals of homebuyers to said each of the at least one participating realtor, either before or after the homebuyers are referred to said each of the at least one participating realtor;
d. at least one software program hosted on the computer server, the at least one software program operating to receive a profile of a homebuyer from a referring lender, identify a participating realtor suitable for representing the homebuyer referred by the referring lender, and refer the homebuyer to the participating realtor using the database containing the at least one referring lender and the database containing the at least one participating realtor.

18. The computer-implemented system and network for facilitating real estate sales of claim 17, wherein the at least one software program operating to receive a profile of a homebuyer from a referring lender identifies the participating realtor suitable for representing the homebuyer referred by the referring lender based on the analysis of a geographical area the homebuyer would like to purchase the home in.

19. The computer-implemented system and network for facilitating real estate sales of claim 17, wherein the network is selected from a group consisting from the Internet, a Wireless Network, a Wide Area Network, and a Local Area Network.

20. The computer-implemented system and network for facilitating real estate sales of claim 17, further comprising a graphical user interface installed on a computer of the at least one remote user, said at least one remote user being the at least one referring lender or the at least one participating realtor, for the at least one user's interaction with the system.
